(19) United States
(12) Patent Application Publication
(10) Pub. No.: US 2014/0248817 A1
(43) Pub. Date: Sep. 4, 2014

(54) MANUFACTURING METHOD FOR DISPLAY DEVICE PROVIDED WITH THIN FILM ELECTRONIC CIRCUIT

(71) Applicant: Sharp Kabushiki Kaisha, Osaka (JP)

(72) Inventors: Mikihiro Noma, Osaka (JP); Tomotoshi Tsujioka, Osaka (JP); Minoru Mayumi, Osaka (JP); Takatoshi Kira, Osaka (JP); Hiroki Makino, Osaka (JP); Gen Nagaoka, Osaka (JP)

(73) Assignee: SHARP KABUSHIKI KAISHA, Osaka (JP)

(21) Appl. No.: 14/350,653

(22) PCT Filed: Oct. 5, 2012
(86) PCT No.: PCT/JP2012/006451

§ 371 Date: Apr. 9, 2014

(30) Foreign Application Priority Data
Oct. 12, 2011 (JP) 2011-225190

(51) Int. Cl. G02F 1/1333

(52) U.S. Cl. CPC G02F 1/13338
USPC 445/24

(57) ABSTRACT

A method of manufacturing a display device provided with a thin-film electronic circuit 11 includes: forming the thin-film electronic circuit 11 having a glass substrate 21 that is temporarily attached to a support member 23 by thinning the glass substrate 21 through etching while the glass substrate 21 is temporarily attached to the support member 23; attaching the thin-film electronic circuit 11 that is temporarily attached to the support member 23 to a display panel; and peeling off the support member 23 from the thin-film electronic circuit 11 attached to the display panel.

### TECHNICAL FIELD

The present invention relates to a method of manufacturing a display device provided with a thin-film electronic circuit.

### BACKGROUND ART

Demand has been growing recently for display devices provided with touch panels, which are thin-film electronic circuits, for the display part of the smartphone and the like, for example. Such a display device has a configuration in which a touch panel is affixed to a display panel such as a liquid crystal display panel, for example.

In general, there is demand for thin display devices (flat display panels) to be much thinner, but the thickness of the touch panel itself in the display device inhibits the display device from being made thinner. Accordingly, it is desirable for the thickness of the touch panel to be reduced.

If the thickness of the glass substrate constituting the touch panel, however, is less than 0.2 mm, then the handling of the glass substrate during the manufacturing process thereof will be very difficult.

A method to manufacture a thin glass substrate is disclosed in Patent Document 1. The method of manufacturing a glass substrate disclosed in Patent Document 1 first involves temporarily attaching a support member to one of the surfaces of the glass substrate. Next, after the other surface of the glass substrate is etched, a film base material is attached to this other surface through an adhesive agent. Thereafter, a glass substrate with a film base material bonded thereto is manufactured by peeling the support member from the one surface of the glass substrate.

### RELATED ART DOCUMENT

### Patent Document

Patent Document 1: Japanese Patent No. 4565670

### SUMMARY OF THE INVENTION

### Problem to be Solved by the Invention

However, in the method of manufacturing the glass substrate in Patent Document 1 above, the thickness of the glass substrate itself can be made thinner, but the limit to such thinness is approximately 0.1 mm as a whole due to the glass substrate, the adhesive agent, and the film base material requiring a certain degree of thickness.

The present invention was made in view of the above, and primarily aims at making a thin-film electronic circuit as thin as possible in a method of manufacturing a display device provided with this thin-film electronic circuit.

### Means for Solving the Problems

To achieve the above-mentioned aims, the present invention provides a method of manufacturing a display device provided with a thin-film electronic circuit. This includes: forming a thin-film electronic circuit having a glass substrate that is temporarily attached to a support member, the step of forming the thin-film electronic circuit having the glass substrate that is temporarily attached to the support member including thinning the glass substrate through etching while this glass substrate is temporarily attached to the support member; attaching the thin-film electronic circuit that is temporarily attached to the support member to a display panel; and peeling off the support member from the thin-film electronic circuit attached to the display panel.

With this configuration, the support member is peeled off from the thin-film electronic circuit after the thin-film electronic circuit has been attached to the display panel; therefore, this glass substrate can be supported by the display panel itself without attaching other members such as a film base material to the glass substrate, for example. Accordingly, the thickness of the glass substrate can be substantially reduced. Furthermore, the support member is peeled from the thin-film electronic circuit and no other members are attached to the glass substrate; thus, the luminosity of display light passing through the thin-film electronic circuit can be increased, and the chromaticity of the display light can be successfully maintained.

The step of forming a thin-film electronic circuit may include: temporarily attaching the glass substrate to the support member; thinning the glass substrate that is temporarily attached to the support member through etching; forming an electrode layer for detecting a touch location on a surface of the thinned glass substrate opposite to the support member.

With this configuration, the glass substrate that has been thinned is temporarily attached to the support member; therefore, the electrode layer can be reliably formed on the thin glass substrate, which is handled with ease.

The step of forming a thin-film electronic circuit may include: forming an electrode layer for detecting a touch location on a surface of the glass substrate; temporarily attaching a side of the glass substrate where the electrode layer is formed to the support member; and thinning the glass substrate that is temporarily attached to the support member through etching.

With this configuration, in addition to being able to reliably form the electrode layer on the glass substrate that is relatively thick before etching, the electrode layer is arranged on the side of the glass substrate opposite to the display panel; therefore, the touch location is easier to detect and the effects of noise from the display panel on touch location detection can be reduced.

In the step of attaching the thin-film electronic circuit to the display panel, the thin-film electronic circuit may be attached to the display panel through a first adhesive layer, and in the step of forming the thin-film electronic circuit, the thin-film electronic circuit may be temporarily attached to the support member through a second adhesive layer having a weaker adhesive strength than the first adhesive layer.

With this configuration, the adhesive strength of the second adhesive layer interposed between the thin-film electronic circuit and the support member is less than the adhesive strength of the first adhesive layer interposed between the thin-film electronic circuit and the display panel; thus, the support member can be peeled off along with the second adhesive layer from the thin-film electronic circuit while the thin-film electronic circuit is attached to the display panel side by the first adhesive layer.

The display panel may be a liquid crystal display panel provided with a first substrate and a second substrate that faces the first substrate, the electrode layer may have a prescribed pattern, in the step of attaching the thin-film electronic circuit to the display panel, the thin-film electronic circuit may be attached to the second substrate, and a polarizing plate may be attached to a surface of the thin-film electronic circuit opposite to the second substrate.

With this configuration, the polarizing plate is arranged on the side of the thin-film circuit substrate opposite to the second substrate; therefore, it is possible to make the prescribed patterns of the electrode layer formed on the thin-film electronic circuit difficult for the user to see.

### Effects of the Invention

According to the present invention, the support member is peeled from the thin-film electronic circuit after the thin-film electronic circuit has been attached to the display panel; therefore, this glass substrate can be supported by the display panel itself without attaching other members such as a film base material to the glass substrate, for example. As a result, the glass substrate can be handled with ease and the thickness thereof can be substantially reduced. Furthermore, the support member is peeled from the thin-film electronic circuit and no other members to support the glass substrate are attached to the glass substrate; thus, the luminosity of display light passing through the thin-film electronic circuit can be increased, and the chromaticity of the display light can be successfully maintained.

### BRIEF DESCRIPTION OF THE DRAWINGS

FIG. 1 is a schematic cross-sectional view of a liquid crystal display device provided with a touch panel according to Embodiment 1.

FIG. 2 is a cross-sectional view of a glass substrate attached to a resin film.

FIG. 3 is a cross-sectional view of the glass substrate after being etched.

FIG. 4 is a cross-sectional view of a touch panel multilayer body having an electrode layer formed on the glass substrate.

FIG. 5 is a cross-sectional view of the touch panel multilayer body arranged facing a first adhesive layer.

FIG. 6 is a cross-sectional view of the touch panel attached to a liquid crystal display panel through the first adhesive layer.

FIG. 7 is a cross-sectional view of the resin film peeled from the touch panel.

FIG. 8 is a side view of an upper stage and a lower stage.

FIG. 9 is a side view of a roller rolling on an adhesive film.

FIG. 10 is a side view of the touch panel peeled off by the adhesive film.

FIG. 11 is a side view of the liquid crystal display panel after the touch panel has been peeled off.

FIG. 12 is a schematic cross-sectional view of a liquid crystal display device provided with a touch panel according to Embodiment 2.

FIG. 13 is a cross-sectional view of an electrode layer formed on a relatively thick glass substrate.

FIG. 14 is a cross-sectional view of the electrode layer and the glass substrate attached to a resin film.

FIG. 15 is a cross-sectional view of a touch panel multilayer body 18 formed by etching the glass substrate.

FIG. 16 is a cross-sectional view of the touch panel multilayer body arranged facing a first adhesive layer.

FIG. 17 is a cross-sectional view of the touch panel attached to a liquid crystal display panel through a first adhesive layer.

FIG. 18 is a cross-sectional view of the resin film peeled from the touch panel.

FIG. 19 is a schematic cross-sectional view of a liquid crystal display device provided with a touch panel according to Embodiment 3.

FIG. 20 is a cross-sectional view of a touch panel multilayer body arranged facing a first adhesive layer.

FIG. 21 is a cross-sectional view of the touch panel attached to a liquid crystal display panel through the first adhesive layer.

FIG. 22 is a cross-sectional view of a resin film peeled from the touch panel.

FIG. 23 is a cross-sectional view of the touch panel multilayer body arranged facing a glass cover.

FIG. 24 is a cross-sectional view of the touch panel multilayer body arranged facing the first adhesive layer.

FIG. 25 is a plan view of the first adhesive layer.

### DETAILED DESCRIPTION OF EMBODIMENTS

Embodiments of the present invention will be described in detail below with reference to drawings. The present invention is not limited to the embodiments below.

### Embodiment 1

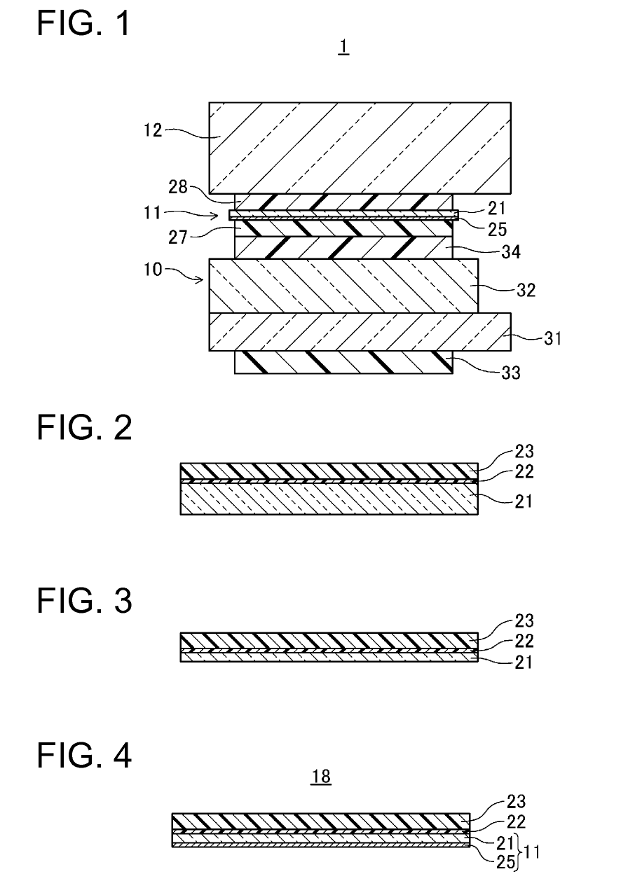

FIGS. 1 to 11 show Embodiment 1 of the present invention.

FIG. 1 is a schematic cross-sectional view of a liquid crystal display device 1 provided with a touch panel 11 according to Embodiment 1.

In the present embodiment, the liquid crystal display device 1 will be described as an example of the display device of the present invention. As shown in FIG. 1, the liquid crystal display device 1 includes: a liquid crystal display panel 10, which is a display panel; the touch panel 11, which is a thin-film electronic circuit stacked on the liquid crystal display panel 10; and a glass cover 12, which is a covering substrate stacked on the side of the touch panel 11 opposite to the liquid crystal display panel 10. Although not shown in the drawings, the liquid crystal display device 1 includes a backlight unit, which is an illumination device arranged on the side of the liquid crystal display panel 10 opposite to the touch panel 11.

The liquid crystal display panel 10 has a first substrate 31 as an active matrix substrate, and a second substrate 32 that faces the first substrate, for example. A liquid crystal layer (not shown) is sealed between the first substrate 31 and the second substrate. A polarizing plate 33 is attached to the side of the first substrate 31 opposite to the second substrate 32. Meanwhile, a polarizing plate 34 is attached to the side of the second substrate 32 opposite to the first substrate 31.

The touch panel 11 is attached to the polarizing plate 34 through a first adhesive layer 27. The glass cover 12 is attached to the touch panel 11 through a third adhesive layer 28. The first adhesive layer 27 and third adhesive layer 28 are transparent double-sided adhesive tapes or the like made of acrylic or the like, for example.

The touch panel 11 is of a capacitive type and has a glass substrate 21 and an electrode layer 25 formed on a surface of this glass substrate 21. The thickness of the glass substrate 21 is less than or equal to 0.2 mm. The electrode layer 25 is formed on the surface of the glass substrate 21 facing the liquid crystal display panel 10. The electrode layer 25 is a transparent conductive film made of ITO (indium tin oxide) or the like formed in a prescribed pattern, and the electrode layer 25 is covered by an interlayer insulating film (not shown) or the like. The electrode layer 25 is formed by aggregating a plurality of ITO patterns, for example.

The liquid crystal display device 1 performs a desired display by selectively allowing light from the backlight unit to pass through. Meanwhile, when a user touches the glass cover 12 with a fingertip, the touch panel 11 detects the touch location and the like of the fingertip on the basis of changes in capacitance between the fingertip and the electrode layer 25.

—Method of Manufacturing—

Next, a method of manufacturing the liquid crystal display device 1 will be described with reference to FIGS. 1 to 8.

FIG. 2 is a cross-sectional view of the glass substrate 21 attached to a resin film 23. FIG. 3 is a cross-sectional view of the glass substrate 21 after being etched. FIG. 4 is a cross-sectional view of a touch panel multilayer body 18 having the electrode layer 25 formed on the glass substrate 21.

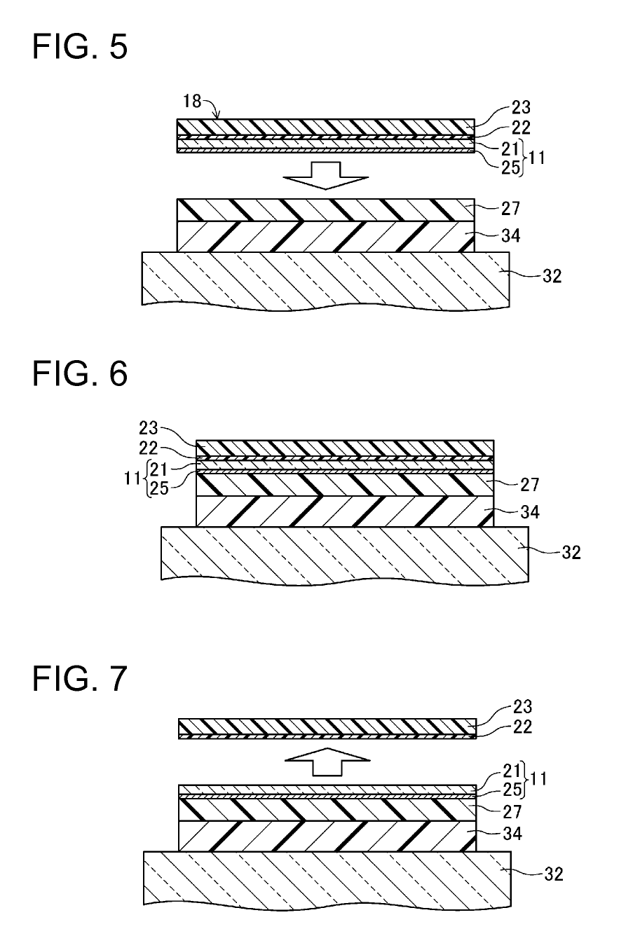

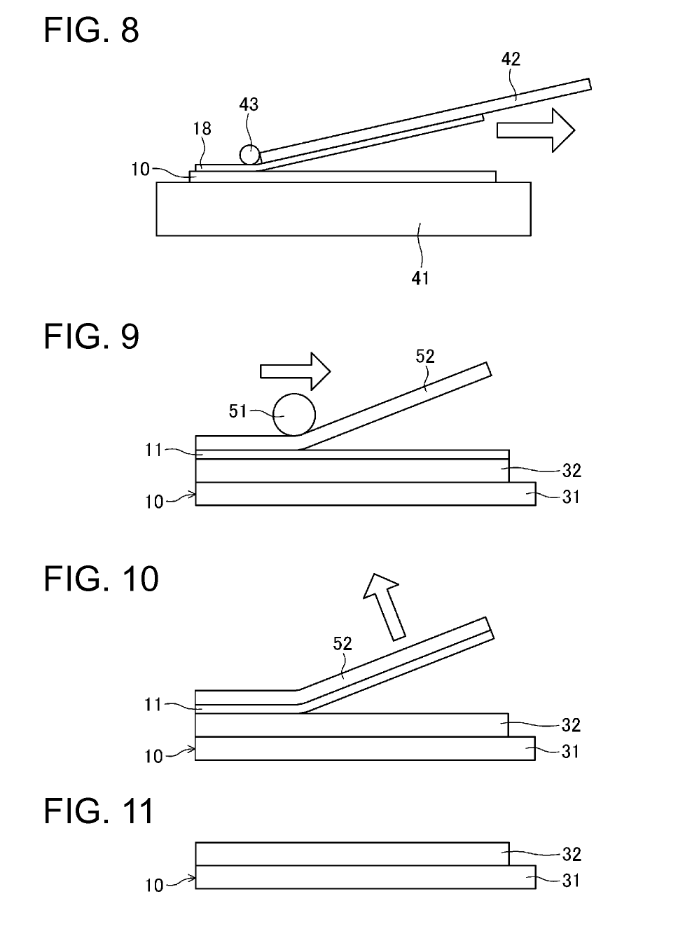

FIG. 5 is a cross-sectional view of the touch panel multilayer body 18 arranged facing the first adhesive layer 27. FIG. 6 is a cross-sectional view of the touch panel 11 attached to the liquid crystal display panel 10 through the first adhesive layer 27. FIG. 7 is a cross-sectional view of the resin film 23 peeled off from the touch panel 11. FIG. 8 is a side view of an upper stage 42 and a lower stage 41.

(Formation of Touch Panel)

First, the glass substrate 21 is temporarily attached to the resin film 23, which is the support member. In other words, as shown in FIG. 2, the relatively thick glass substrate 21 is attached to the resin film 23 through a second adhesive layer 22. The adhesive strength of the second adhesive layer 22 is less than the adhesive strength of the first adhesive layer. The second adhesive layer 22 can be formed of a thermal foam sheet or the like that has had the adhesive strength thereof lowered by heating, for example.

Next, the glass substrate 21 is made thinner by etching. In other words, as shown in FIG. 3, this glass substrate 21 is made thinner by immersing the glass substrate 21 in an etchant while the glass substrate 21 is temporarily attached to the resin film 23.

Next, the electrode layer 25 is formed. In other words, as shown in FIG. 4, the electrode layer 25 for detecting touch location is formed on the surface of the thinned glass substrate 21 opposite to the resin film 23. The electrode layer 25 is a transparent conductive film made of ITO or the like formed in prescribed patterns, for example. An interlayer insulating film (not shown) or the like that covers the electrode layer 25 is formed on the glass substrate 21. In this manner, the touch panel 11 having the glass substrate 21 temporarily attached to the resin film 23 is formed. Namely, the touch panel multilayer body 18 having the touch panel 11 and resin film 23 stacked through the second adhesive layer 22 is formed.

(Attachment of Touch Panel)

Next, the touch panel 11 is attached to the liquid crystal display panel 10. In other words, as shown in FIGS. 5 and 6, the touch panel 11 (touch panel multilayer body 18) that is temporarily attached to the resin film 23 is attached to the polarizing plate 34 through the first adhesive layer 27.

At this time, as shown in FIG. 8, first the upper stage 42 that holds the touch panel multilayer body 18 on the bottom thereof through adsorption is arranged above the lower stage 41 while the liquid crystal display panel 10 is fixed to the top of the lower stage 41. Next, an end of the touch panel multilayer body 18 is pressed towards the liquid crystal display panel 10 with a roller 43, and the roller 43 and the upper stage 42 slide along the top of the bottom stage 41.

In this manner, the touch panel multilayer body 18 can be firmly attached to the liquid crystal display panel 10. The glass substrate 21 is able to be made very thin; therefore, the touch panel multilayer body 18 can have flexibility as a whole. Accordingly, the attachment work of the touch panel multilayer body 18 by the roller 43 can be performed in air instead of in a vacuum.

In this manner, as shown in FIG. 6, the electrode layer 25 is arranged on the side of the glass substrate 21 facing the second substrate 32 in order to attach the touch panel multilayer body 18 to the liquid crystal display panel 10.

(Peeling Off Resin Film)

Next, the resin film 23 is peeled off. In other words, as shown in FIG. 7, the resin film 23 is peeled from the touch panel 11 attached to the liquid crystal display panel 10. At this time, due to the adhesive strength of the second adhesive layer 22 being less than the adhesive strength of the first adhesive layer 27, the resin film 23 and the second adhesive layer 22 are peeled from the glass substrate 21 of the touch panel 11 while the touch panel 11 is attached to the liquid crystal display panel 10 side by the first adhesive layer 27.

Thereafter, as shown in FIG. 1, the glass substrate 21 of the touch panel 11 is attached to the glass cover 12 through the third adhesive layer 28. In this manner, the liquid crystal display device 1 provided with the touch panel 11 is manufactured.

—Method of Repair—

Next, a method of repairing the liquid crystal display panel 10 having the touch panel 11 attached thereto will be explained with reference to FIGS. 9 to 11.

FIG. 9 is a side view of a roller 51 rolling on an adhesive film 52. FIG. 10 is a side view of the touch panel 11 being peeled by the adhesive film 52. FIG. 11 is a side view of the liquid crystal display panel 10 after the touch panel 11 has been peeled off.

If foreign matter enters between the touch panel 11 and the liquid crystal display panel 10 or the like, then the touch panel 11 can be pulled off the liquid crystal display panel 10 in order to reuse the liquid crystal display panel 10. In this case, as shown in FIG. 9, first the roller 51 is rolled from side to side on the touch panel 11 while the end of the adhesive film 52 that is adhesive only on the bottom is pushed towards the touch panel 11 by this roller 51. In this manner, the adhesive film 52 is firmly attached to the touch panel 11.

Next, as shown in FIG. 10, the end of the adhesive film 52 is pulled off from the liquid crystal display panel 10, thereby peeling off the touch panel 11 from the liquid crystal display panel 10 while the touch panel 11 is held to the adhesive film 52 by adsorption. In this manner, as shown in FIG. 11, the liquid crystal display panel 10 having the touch panel 11 removed therefrom can be obtained. Thus, the liquid crystal display panel 10 can be reused by reattaching the touch panel 11 to the liquid crystal display panel 10 as shown in FIG. 8.

### Effects of Embodiment 1

Therefore, according to Embodiment 1, the resin film 23 is peeled from the touch panel 11 after the touch panel 11 has been attached to the liquid crystal display panel 10; thus, the glass substrate 21 can be supported by the liquid crystal display panel 10 itself without attaching other members such as a film base material to the glass substrate 21, for example. Accordingly, the glass substrate 21 can be handled with ease and the thickness thereof can be substantially reduced. Furthermore, the resin film 23 is peeled from the touch panel 11 and no other members to support the glass substrate 21 are attached to the glass substrate 21; thus, the luminosity of display light passing through the touch panel 11 can be increased, and the chromaticity of the display light can be successfully maintained.

The thinned glass substrate 21 is temporarily attached to the resin film 23; therefore, the electrode layer 25 can be reliably formed on the thin glass substrate 21, which is handled with ease.

The adhesive strength of the second adhesive layer 22 interposed between the touch panel 11 and the resin film 23 is less than the adhesive strength of the first adhesive layer 27 interposed between the touch panel 11 and the liquid crystal display panel 10; thus, the resin film 23 can be peeled off along with the second adhesive layer 22 from the touch panel 11 while the touch panel 11 is attached to the liquid crystal display panel 10 by the first adhesive layer 27.

### Embodiment 2

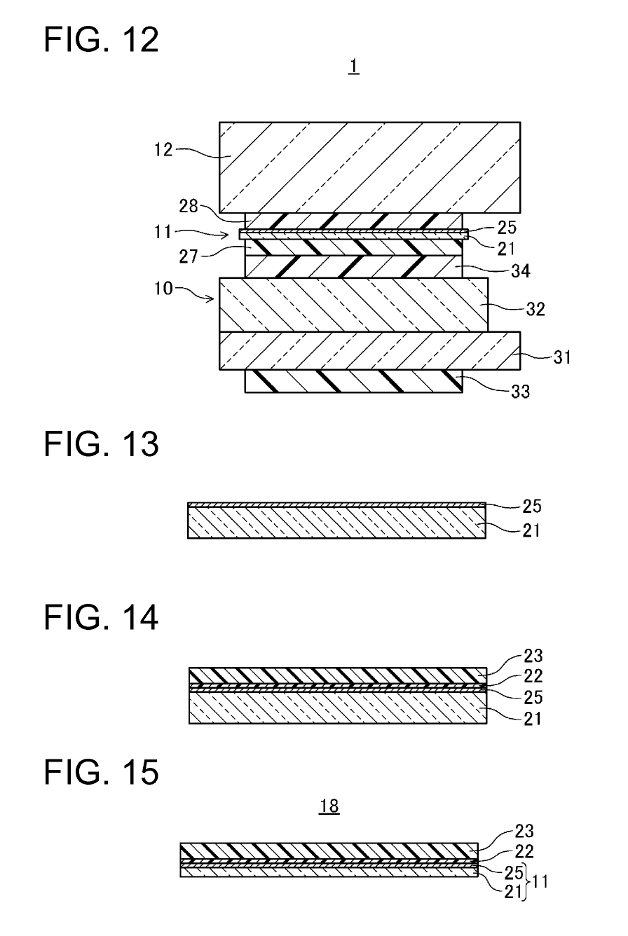

FIGS. 12 to 18 show Embodiment 2 of the present invention.

FIG. 12 is a schematic cross-sectional view of a liquid crystal display device 1 provided with a touch panel 11 according to Embodiment 2. In each embodiment below, parts that are the same as FIGS. 1 to 11 are assigned the same reference characters and detailed descriptions thereof will be omitted.

In Embodiment 1 described above, the electrode layer 25 forming a part of the touch panel 11 is arranged on the side of the glass substrate 21 facing the liquid crystal display panel 10, whereas in the liquid crystal display device 1 of Embodiment 2, an electrode layer 25 is arranged on the side of a glass substrate 21 opposite to a liquid crystal display panel 10.

In other words, as shown in FIG. 12, the touch panel 11 of the present embodiment has the glass substrate 21 and the electrode layer 25 formed in a prescribed pattern on one surface of this glass substrate 21, in a manner similar to Embodiment 1. A polarizing plate 34 is attached through a first adhesive layer 27 to the glass substrate 21 of the touch panel 11, while a glass cover 12 is attached through a third adhesive layer 28 to the electrode layer 25 of the touch panel 11.

—Method of Manufacturing—

Next, a method of manufacturing the liquid crystal display device 1 will be described with reference to FIGS. 12 to 18.

FIG. 13 is a cross-sectional view of the electrode layer 25 formed on the relatively thick glass substrate 21. FIG. 14 is a cross-sectional view of the electrode layer 25 and the glass substrate 21 attached to a resin film 23. FIG. 15 is a cross-sectional view of a touch panel multilayer body 18 formed by etching the glass substrate 21.

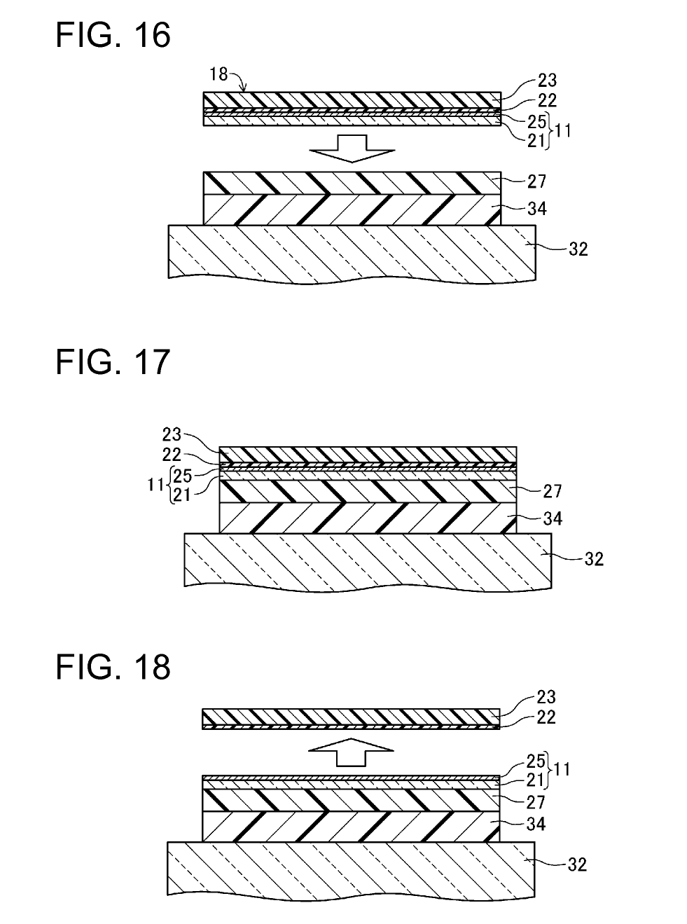

FIG. 16 is a cross-sectional view of the touch panel multilayer body 18 arranged facing the first adhesive layer 27. FIG. 17 is a cross-sectional view of the touch panel 11 attached to a liquid crystal display panel 10 through the first adhesive layer 27. FIG. 18 is a cross-sectional view of the resin film 23 peeled from the touch panel 11.

(Formation of Touch Panel)

First, the electrode layer 25 is formed. In other words, as shown in FIG. 13, the electrode layer 25 for detecting touch location is formed on one surface of the relatively thick glass substrate 21. The electrode layer 25 is a transparent conductive film made of ITO or the like formed in prescribed patterns, for example. An interlayer insulating film (not shown) or the like that covers the electrode layer 25 is formed on the glass substrate 21.

Next, the glass substrate 21 is temporarily attached to the resin film 23, which is the support member. In other words, as shown in FIG. 14, this glass substrate 21 is temporarily attached to the resin film 23 through the second adhesive layer 22 at the side of the relatively thick glass substrate 21 where the electrode layer 25 is formed. The adhesive strength of the second adhesive layer 22 is less than the adhesive strength of the first adhesive layer. The second adhesive layer 22 can be a transparent double-sided adhesive tape or the like made of acrylic or the like, for example.

Next, the glass substrate 21 is made thinner by etching. In other words, as shown in FIG. 15, this glass substrate 21 is made thinner by immersing the glass substrate 21 in an etchant while the glass substrate 21 is temporarily attached to the resin film 23.

In this manner, the touch panel 11 (touch panel multilayer body 18) having the glass substrate 21 temporarily attached to the resin film 23 is formed.

(Attachment of Touch Panel)

Next, the touch panel 11 is attached to the liquid crystal display panel 10. In other words, as shown in FIGS. 16 and 17, the touch panel 11 (touch panel multilayer body 18) temporarily attached to the resin film 23 is attached to the polarizing plate 34 through the first adhesive layer 27. In this manner, as shown in FIG. 17, the electrode layer 25 is arranged on the side of the glass substrate 21 opposite to the liquid crystal display panel 10 in order to attach the touch panel multilayer body 18 to the liquid crystal display panel 10.

(Peeling Off Resin Film)

Next, the resin film 23 is peeled off. In other words, as shown in FIG. 18, the resin film 23 is peeled from the touch panel 11 attached to the liquid crystal display panel 10. At this time, due to the adhesive strength of the second adhesive layer 22 being less than the adhesive strength of the first adhesive layer 27, the resin film 23 and the second adhesive layer 22 are peeled from the glass substrate 21 of the touch panel 11 while the touch panel 11 is attached to the liquid crystal display panel 10 side by the first adhesive layer 27.

Thereafter, as shown in FIG. 12, the touch panel 11 is attached to the glass cover 12 through the third adhesive layer 28 on the electrode layer 25 side of the glass substrate 21. In this manner, the liquid crystal display device 1 provided with the touch panel 11 is manufactured.

### Effects of Embodiment 2

Therefore, according to Embodiment 2, the resin film 23 is peeled from the touch panel 11 after the touch panel 11 has been attached to the liquid crystal display panel 10, in a manner similar to Embodiment 1; thus, the glass substrate 21 can be supported by the liquid crystal display panel 10 itself without attaching other members such as a film base material to the glass substrate 21, for example. Accordingly, the glass substrate 21 can be handled with ease and the thickness thereof can be substantially reduced. Furthermore, the resin film 23 is peeled from the touch panel 11 and no other members to support the glass substrate 21 are attached to the glass substrate 21; thus, the luminosity of display light passing through the touch panel 11 can be increased, and the chromaticity of the display light can be successfully maintained.

In addition to being able to reliably form the electrode layer 25 on the glass substrate 21 that is relatively thick before etching, the electrode layer 25 is arranged on the side of the glass substrate 21 opposite to the liquid crystal display panel 10; therefore, the touch location is easier to detect and the effects of noise from the liquid crystal display panel 10 on touch location detection can be reduced.

### Embodiment 3

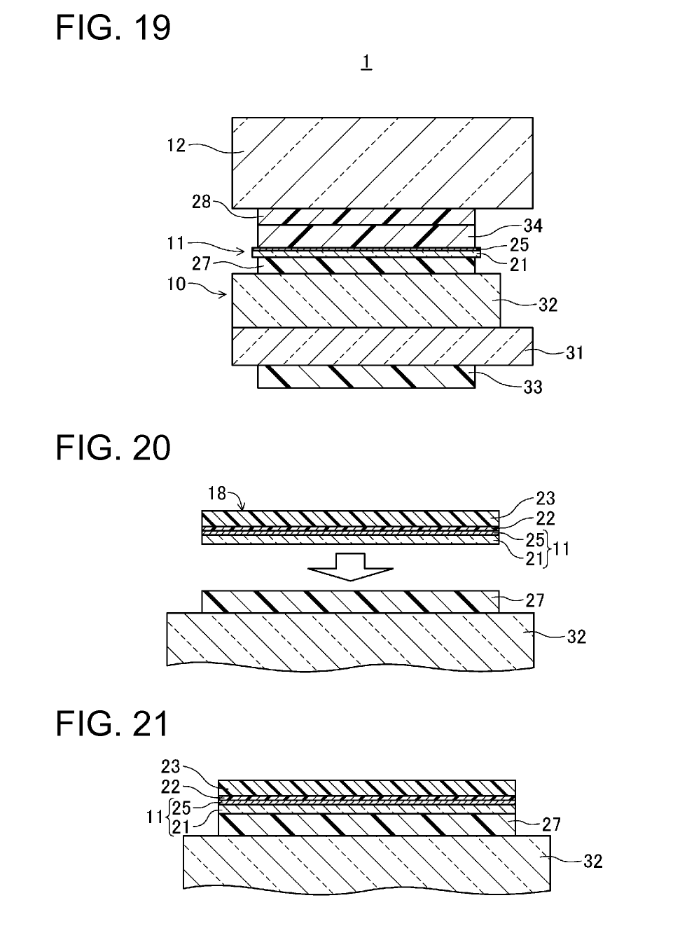

FIGS. 19 to 22 show Embodiment 3 of the present invention.

FIG. 19 is a schematic cross-sectional view of a liquid crystal display device 1 provided with a touch panel 11 according to Embodiment 3.

In Embodiment 2 described above, the polarizing plate 34 was arranged between the touch panel 11 and the second substrate 32, whereas in the liquid crystal display device 1 of Embodiment 3, a polarizing plate 34 is arranged between the touch panel 11 and a glass cover 12.

In other words, as shown in FIG. 19, the touch panel 11 of the present embodiment has a glass substrate 21 and an electrode layer 25 formed in a prescribed pattern on one surface of this glass substrate 21, in a manner similar to Embodiment 2 described above. The glass substrate 21 of the touch panel 11 is attached to a second substrate 32 through a first adhesive layer 27, and the electrode layer 25 of the touch panel 11 is attached to the polarizing plate 34.

—Method of Manufacturing—

Next, a method of manufacturing the liquid crystal display device 1 will be described with reference to FIGS. 19 to 22.

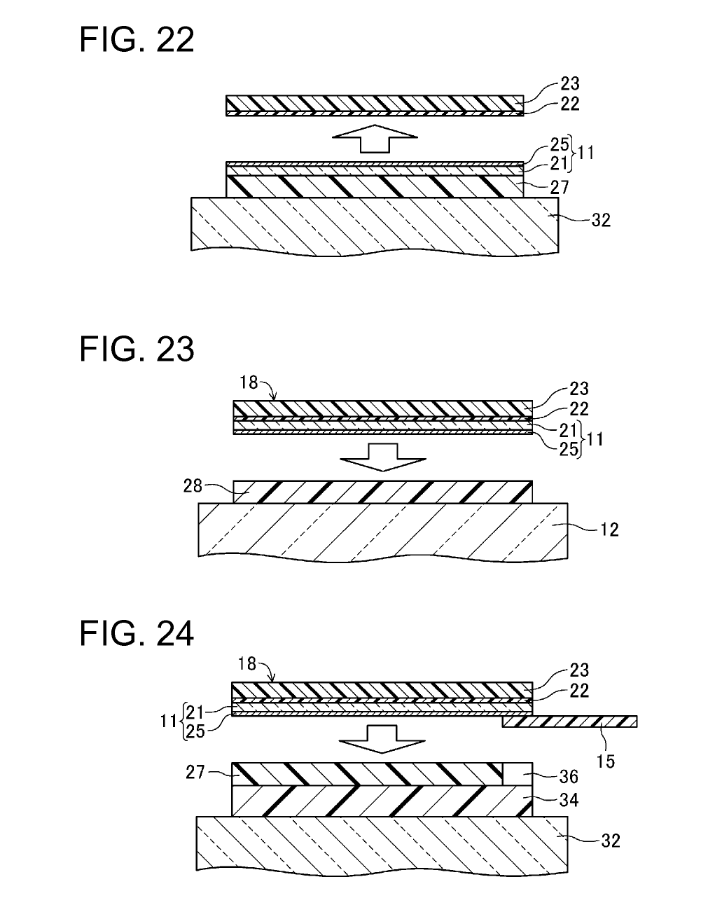

FIG. 20 is a cross-sectional view of a touch panel multilayer body 18 arranged facing the first adhesive layer 27. FIG. 21 is a cross-sectional view of the touch panel 11 attached to the liquid crystal display panel through the first adhesive layer 27. FIG. 22 is a cross-sectional view of a resin film 23 peeled from the touch panel 11.

(Formation of Touch Panel)

First, the touch panel 11 (touch panel multilayer body 18) having the glass substrate 21 temporarily attached to the resin film 23 is formed by the step of forming the touch panel, in a manner similar to Embodiment 2.

(Attachment of Touch Panel)

Next, the touch panel 11 is attached to the liquid crystal display panel 10. In other words, as shown in FIGS. 20 and 21, the touch panel 11 temporarily attached to the resin film 23 (touch panel multilayer body 18) is attached to the second substrate 32 through the first adhesive layer 27. In this manner, as shown in FIG. 21, the electrode layer 25 is arranged on the side of the glass substrate 21 opposite to the liquid crystal display panel 10 in order to attach the touch panel multilayer body 18 to the liquid crystal display panel 10.

(Peeling Off Resin Film)

Next, the resin film 23 is peeled off. In other words, as shown in FIG. 22, the resin film 23 is peeled from the touch panel 11 attached to the liquid crystal display panel 10. At this time, due to the adhesive strength of the second adhesive layer 22 being less than the adhesive strength of the first adhesive layer 27, the resin film 23 and the second adhesive layer 22 are peeled from the glass substrate 21 of the touch panel 11 while the touch panel 11 is attached to the liquid crystal display panel 10 side by the first adhesive layer 27.

Thereafter, as shown in FIG. 19, the polarizing plate 34 is attached to the surface of the touch panel 11 opposite to the second substrate 32. Then, the glass cover 12 is attached to the polarizing plate 34 through a third adhesive layer 28. In this manner, the liquid crystal display device 1 provided with the touch panel 11 is manufactured.

### Effects of Embodiment 3

Therefore, according to Embodiment 3, the glass substrate 21 of the touch panel 11 can be supported by the liquid crystal display panel 10 itself, in a manner similar to Embodiments 1 and 2; thus, the glass substrate 21 can be handled with ease and the thickness thereof can be substantially reduced. Furthermore, the resin film 23 is peeled from the touch panel 11 and no other members to support the glass substrate 21 are attached to the glass substrate 21; thus, the luminosity of display light passing through the touch panel 11 can be increased, and the chromaticity of the display light can be successfully maintained.

By arranging the polarizing plate 34 on the side of the touch panel 11 opposite to the second substrate 32, the user sees the touch panel 11 through the polarizing plate 34; therefore, it is possible to make the prescribed patterns of the electrode layer 25 formed on the touch panel 11 difficult for the user to see.

In particular, the prescribed patterns of the electrode layer 25 can be made even more difficult for the user to see by using a circularly polarizing plate as the polarizing plate 34.

### Embodiment 4

FIG. 23 shows Embodiment 4 of the present invention.

FIG. 23 is a cross-sectional view of a touch panel multilayer body 18 arranged facing a glass cover 12.

In Embodiments 1 to 3 above, the liquid crystal display device 1 is manufactured with the touch panel multilayer body 18 attached to the liquid crystal display panel 10 side, whereas in Embodiment 4, a liquid crystal display device 1 is manufactured with the touch panel multilayer body 18 attached to the glass cover 12 side. The liquid crystal display device 1 of Embodiment 4 has a similar configuration to the liquid crystal display device 1 of Embodiment 2.

In the method of manufacturing in the present embodiment, as shown in FIG. 23, the touch panel multilayer body 18 is attached to the glass cover 12 through a third adhesive layer 28 after the touch panel multilayer body 18 has been formed, in a manner similar to Embodiment 1.

Thereafter, a resin film 23 is peeled from a touch panel 11 attached to the glass cover 12. The adhesive strength of a second adhesive layer 22 included in the touch panel multilayer body 18 is less than the adhesive strength of the third adhesive layer 28; therefore, at the time of peeling the resin film 23, the resin film 23 and the second adhesive layer 22 are peeled off from a glass substrate 21 of the touch panel 11 while the touch panel 11 is attached to the glass cover 12 side by the third adhesive layer 28.

Thereafter, as shown in FIG. 12, the glass substrate 21 side of the touch panel 11 is attached to the liquid crystal display panel 10 through a first adhesive layer 27. In this manner, the liquid crystal display device 1 provided with the touch panel 11 is manufactured.

Therefore, according to Embodiment 4, the glass substrate 21 of the touch panel 11 can be supported by the glass cover 12 itself; thus, the glass substrate 21 can be handled with ease and the thickness thereof can be substantially reduced. Furthermore, the resin film 23 is peeled from the touch panel 11 and no other members to support the glass substrate 21 are attached to the glass substrate 21; thus, the luminosity of display light passing through the touch panel 11 can be increased, and the chromaticity of the display light can be successfully maintained

### Embodiment 5

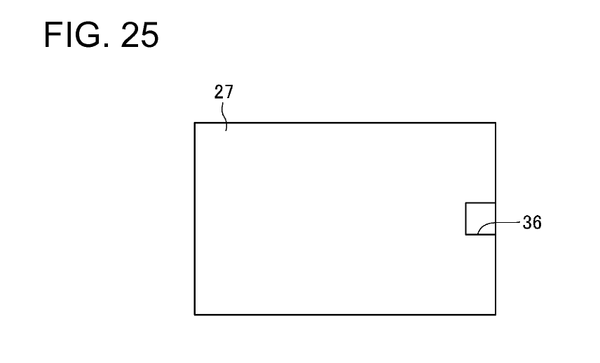

FIGS. 24 and 25 show Embodiment 5 of the present invention.

FIG. 24 is a cross-sectional view of a touch panel multilayer body 18 arranged facing a first adhesive layer 27. FIG. 25 is a plan view of the first adhesive layer 27.

The present embodiment is similar to Embodiment 1 and has an FPC (flexible printed circuit) 15, which is a film substrate, provided on the touch panel 11. In other words, as shown in FIG. 24, the FPC 15 that is electrically connected to an electrode layer 25 is mounted by compression on an end of the touch panel 11. Meanwhile, a cut-out 36 is formed in the first adhesive layer 27 to which the touch panel 11 will be attached, and a portion of the FPC 15 fits into this cut-out 36. As shown in FIG. 25, the cut-out 36 has a rectangular shape formed on an end of the first adhesive layer 27, for example. As shown in FIG. 24, the thickness of the first adhesive layer 27 is greater than the thickness of the mounting portion of the FPC 15.

When manufacturing a liquid crystal display device 1 of the present embodiment, first, the first adhesive layer 27 having the cut-out 36 is attached to a polarizing plate 34. Thereafter, the touch panel multilayer body 18 is attached to the polarizing plate 34 through the first adhesive layer 27 such that a portion of the FPC 15 fits inside the cut-out 36. In this way, the liquid crystal display device 1 is manufactured, in a manner similar to Embodiment 1.

Therefore, according to the present embodiment, in addition to achieving similar effects to Embodiment 1, an overlap of the first adhesive layer 27 and the FPC 15 is avoided, even if the touch panel 11 has the FPC 15, by providing the cut-out 36 in the first adhesive layer 27; therefore, the liquid crystal display device 1 can be made thinner as a whole.

### Other Embodiments

The second adhesive layer 22 can be a photodegradable sheet, the adhesive strength thereof being reduced when light is incident on the sheet. In addition, the second adhesive layer 22 can be a material with an adhesive force that is weak enough to be peeled off with ease after being adhered to an object.

In Embodiment 3, an example was described in which the electrode layer 25 of the touch panel 11 was formed on the side of the glass substrate 21 opposite to the liquid crystal display panel 10, but without being limited thereto, the electrode layer 25 may be formed on the side of the glass substrate 21 facing the liquid crystal display panel 10.

After the touch panel multilayer body 18 has been attached to the rear surface of a mobile device or the like opposite to the display surface, the resin film 23 and the second adhesive layer 22 may be peeled off from the touch panel 11.

In the respective embodiments described above, the touch panel 11 was described as a thin-film electronic circuit as an example, but in addition to the touch panel, a thin-film electronic circuit having various types of sensors, a thin-film electronic circuit having an OLED (organic light-emitting diode), a thin-film electronic circuit having TFTs, a thin-film electronic circuit having a micromachine, or the like, for example, can also be applied to the present invention.

### INDUSTRIAL APPLICABILITY

As described above, the present invention is useful for a method of manufacturing a display device provided with a thin-film electronic circuit.

### DESCRIPTION OF REFERENCE CHARACTERS

1 liquid crystal display device

10 liquid crystal display panel

11 touch panel (thin-film electronic circuit)

21 glass substrate

22 second adhesive layer

23 resin film (support member)

25 electrode layer

27 first adhesive layer

28 third adhesive layer

31 first substrate

32 second substrate

34 polarizing plate

1. A method of manufacturing a display device provided with a thin-film electronic circuit, comprising:
forming a thin-film electronic circuit having a glass substrate that is temporarily attached to a support member, the step of forming the thin-film electronic circuit having the glass substrate that is temporarily attached to the support member including thinning the glass substrate through etching while said glass substrate is temporarily attached to the support member;
attaching the thin-film electronic circuit that is temporarily attached to the support member to a display panel; and
peeling off the support member from the thin-film electronic circuit attached to the display panel.

2. The method of manufacturing a display device provided with a thin-film electronic circuit according to claim 1,
wherein the step of forming a thin-film electronic circuit includes:
temporarily attaching the glass substrate to the support member;
thinning the glass substrate that is temporarily attached to the support member through etching;
forming an electrode layer for detecting a touch location on a surface of the thinned glass substrate opposite to the support member.

3. The method of manufacturing a display device provided with a thin-film electronic circuit according to claim 1,
wherein the step of forming a thin-film electronic circuit includes:
forming an electrode layer for detecting a touch location on a surface of the glass substrate;
temporarily attaching a side of the glass substrate where the electrode layer is formed to the support member; and
thinning the glass substrate that is temporarily attached to the support member through etching.

4. The method of manufacturing a display device provided with a thin-film electronic circuit according to claim 1,
wherein, in the step of attaching the thin-film electronic circuit to the display panel, the thin-film electronic circuit is attached to the display panel through a first adhesive layer, and
wherein, in the step of forming the thin-film electronic circuit, the thin-film electronic circuit is temporarily attached to the support member through a second adhesive layer having a weaker adhesive strength than the first adhesive layer.

5. The method of manufacturing a display device provided with a thin-film electronic circuit according to claim 2,
wherein the display panel is a liquid crystal display panel provided with a first substrate and a second substrate that faces said first substrate,
wherein the electrode layer has a prescribed pattern,
wherein, in the step of attaching the thin-film electronic circuit to the display panel, the thin-film electronic circuit is attached to the second substrate, and
wherein a polarizing plate is attached to a surface of the thin-film electronic circuit opposite to the second substrate.

6. The method of manufacturing a display device provided with a thin-film electronic circuit according to claim 2,
wherein, in the step of attaching the thin-film electronic circuit to the display panel, the thin-film electronic circuit is attached to the display panel through a first adhesive layer, and
wherein, in the step of forming the thin-film electronic circuit, the thin-film electronic circuit is temporarily attached to the support member through a second adhesive layer having a weaker adhesive strength than the first adhesive layer.

7. The method of manufacturing a display device provided with a thin-film electronic circuit according to claim 3,
wherein, in the step of attaching the thin-film electronic circuit to the display panel, the thin-film electronic circuit is attached to the display panel through a first adhesive layer, and
wherein, in the step of forming the thin-film electronic circuit, the thin-film electronic circuit is temporarily attached to the support member through a second adhesive layer having a weaker adhesive strength than the first adhesive layer.

8. The method of manufacturing a display device provided with a thin-film electronic circuit according to claim 3,
wherein the display panel is a liquid crystal display panel provided with a first substrate and a second substrate that faces said first substrate,
wherein the electrode layer has a prescribed pattern,
wherein, in the step of attaching the thin-film electronic circuit to the display panel, the thin-film electronic circuit is attached to the second substrate, and
wherein a polarizing plate is attached to a surface of the thin-film electronic circuit opposite to the second substrate.
